(19) United States
(12) Patent Application Publication
(10) Pub. No.: US 2022/0058484 A1
(43) Pub. Date: Feb. 24, 2022

(54) METHOD FOR TRAINING A NEURAL NETWORK TO DELIVER THE VIEWPOINTS OF OBJECTS USING UNLABELED PAIRS OF IMAGES, AND THE CORRESPONDING SYSTEM

(71) Applicants: Toyota Jidosha Kabushiki Kaisha, Toyota-shi Aichi-ken (JP); The University Court of the University of Edinburgh, Edinburgh (GB)

(72) Inventors: Sven Meier, Wilsele (BE); Octave Mariotti, Paris (FR); Hakan Bilen, Edinburgh (GB)

(73) Assignees: Toyota Jidosha Kabushiki Kaisha, Toyota-shi Aichi-ken (JP); The University Court of the University of Edinburgh, Edinburgh (GB)

(21) Appl. No.: 17/406,695

(22) Filed: Aug. 19, 2021

(30) Foreign Application Priority Data
Aug. 21, 2020 (EP) 20192258.0

(51) Int. Cl. G06N 3/08; G06K 9/62; G06K 9/00

(52) U.S. Cl. CPC G06N 3/08; G06K 9/00791; G06K 9/6259

(57) ABSTRACT

A system and a method for training a neural network to deliver the viewpoint of objects, the method comprising minimizing distances between each training image of a first set of training images, the output of the neural network with the viewpoint of this training image, and each pair of a second set of training image pairs, the second image of each pair of the second set of training image pairs with the output of a decoder neural network when the first image of this pair is inputted to an encoder neural network, the second image of this pair is inputted to the neural network to obtain a viewpoint, the obtained encoded image is rotated according to the viewpoint, and the rotated encoded image is decoded.

### CROSS-REFERENCE TO RELATED APPLICATION

This application claims priority to European Patent Application No. 20192258.0 filed on Aug. 21, 2020, incorporated herein by reference in its entirety.

### FIELD OF THE DISCLOSURE

The present disclosure is related to the field of data processing using neural networks, for example image processing using neural networks. More precisely, the present disclosure relates to neural networks able to detect viewpoints of objects visible on images.

### DESCRIPTION OF THE RELATED ART

It has been proposed to detect three-dimensional objects on images acquired by cameras by using neural networks implemented on computer systems. Typically, it is desirable to also obtain information relative to the 6D pose of the objects visible on an image. “6D pose” is an expression well known to the person skilled in the art which designates the combination of the three-dimensional position and of the three-dimensional orientation of an object. Obtaining the 6D pose is particularly useful in the field of robotics wherein objects are detected and manipulated. It is also useful to determine the orientation of an object in a driving scene to allow autonomous or partially autonomous driving.

The viewpoint of an object visible on an image is one such information relative to the 6D pose which is desirable. The viewpoint can be defined as the azimuth, the elevation, and the in-plane rotation of an object relative to the camera used to acquire the image. Neural networks have also been used to determine automatically the viewpoint of an object visible on an image.

In order to obtain a neural network which performs the task of determining automatically the viewpoint of an object visible on an image, a training phase of the neural network has to be performed. This training phase is usually performed using a labelled set of training images. By labelled, what is meant is that the viewpoint of an object of interest is provided for each image of the set of training images; the provided viewpoint is called the ground truth. Training then consists in inputting the images from the training set to the neural network, comparing the output of the neural network with the corresponding ground truth, and adapting the parameters of the neural network on the basis of this comparison (for example using the well-known stochastic gradient method).

As is well known in the art, a large number of labelled training images is necessary to obtain a good training of a neural network. Large-scaled labeled datasets have been an important driving force in the advancement of the state-of-the-art in computer vision tasks. However, annotating data is expensive (i.e. time-consuming), and is not scalable to a growing body of complex visual concepts. In fact, obtaining ground truths/labels typically involves using specialized hardware, controlled environments and an operator manually aligning 3D CAS models with real-world objects.

While it is known from the prior art to use labelled datasets to train a neural network to detect viewpoints of objects, how to use unlabeled data remains unclear. It is however desirable to use unlabeled data as it is inexpensive and easier to obtain.

It has been proposed (for example in document “Multi-view object class detection with a 3d geometric model”, Liebelt, J., Schmid, C., 2010 IEEE Computer Society Conference on Computer Vision and Pattern Recognition. pp. 1688-1695. IEEE (2010)) to render 3D CAD images of objects under different viewpoints to train neural networks (the ground truth is therefore known for the rendering). While it is possible to generate a large amount of labeled synthetic data with rendering and simulator tools and learn viewpoint estimators on them, discrepancies between the synthetic and real world images make their transfer challenging. Thus, it has been proposed in document “Render for cnn: Viewpoint estimation in images using cnns trained with rendered 3d model views” (Su, H., Qi, C. R., Li, Y., Guibas, L. J., Proceedings of the IEEE International Conference on Computer Vision. pp. 2686-2694 (2015)) to overlay rendered images from large 3D model collections on top of real images and such methods result in realistic training images and improves the detection of viewpoints when these images are used during training. This solution however requires the existence of a large collection of 3D models and of background scenes, which is also a difficulty.

It has also been proposed in multiple documents to use unlabeled images in processes called self-supervised or unsupervised. In these processes, information is leveraged from unlabeled images to improve the training of the neural network to detect viewpoints or poses.

Document “Unsupervised geometry-aware representation for 3d human pose estimation” (Rhodin, H., Salzmann, M., Fua, P., Proceedings of the European Conference on Computer Vision (ECCV). pp. 750-767 (2018)) discloses an unsupervised method in which an auto-encoder is used to learn to translate an image from a first viewpoint to an image with another viewpoint in a multi-camera setup. This solution is not satisfactory as it requires the knowledge of the rotation between each camera pair.

There is a need for more efficient methods to obtain neural networks which can automatically determine the viewpoint of an object visible on an image.

### SUMMARY OF THE DISCLOSURE

The present disclosure overcomes one or more deficiencies of the prior art by proposing a method for training a neural network to deliver the viewpoint of a given object visible on an image when this image is inputted to this neural network, the method comprising:

providing an encoder neural network configured to receive an image as input and to deliver an encoded image,

providing a decoder neural network configured to receive an encoded image having the same dimensions as an encoded image delivered by the encoder neural network, and configured to output a decoded image (i.e. an image),

providing a first set of training images with, for each image, the viewpoint (i.e. the ground truth) of an object belonging to a given category which is visible on the image,

providing a second set of training image pairs, wherein each pair of the second set of training image pairs comprises:
a first image on which an object belonging to the given category (a category of objects, for example cars, pedestrians, etc.) is visible;
a second image on which the object of the first image is visible with a viewpoint which differs from the viewpoint in the first image,

and wherein training the neural network comprises adapting the parameters of the neural network, the parameters of the encoder neural network, and the parameters of the decoder neural network by minimizing the distances between:
for each training image of the first set of training images, the output of the neural network when the training image is inputted to the neural network, with the viewpoint of this training image,
for each pair of the second set of training image pairs, the second image of each pair of the second set of training image pairs with the output of the decoder neural network when:
   the first image of this pair is inputted to the encoder neural network to obtain an encoded image,
   the second image of this pair is inputted to the neural network to obtain a viewpoint,
   the encoded image is rotated by a rotation corresponding to this viewpoint to obtain a rotated encoded image,
   the rotated encoded image is inputted into the decoder neural network to obtain the output of the decoder neural network.

This method may be implemented on a computing system, for example to perform the training automatically.

In the present description, viewpoint means viewpoint with respect to the camera used to acquire the image on which the object is visible.

Training the neural network can be performed iteratively, for example after each calculation of a distance or after a given number of calculations of distances, the stochastic gradient descent may be used or any other suitable training algorithm or variant of the stochastic gradient descent. The stochastic gradient descent can be used to adapt the parameters of the neural network, the encoder neural network, and the decoder neural network in a manner known in itself. These parameters are, for example the weights of these neural networks. Minimizing the distances comprises calculating a loss to be minimized, and, for example, back-propagating this loss through the decoder neural network, the neural network, and the encoder neural network.

It should be noted that the person skilled in the art will know how to select the structures of the neural network, of the encoder neural network, and of the decoder neural network. For example, the neural network has to be able to receive images having a given resolution as input with a depth of 3 (if it receives RGB images), and it also has to output at least three numbers for representing the viewpoint (azimuth, elevation, in-plane rotation), and this corresponds to given numbers of neurons for the first layer and for the final layer of this neural network.

Also for example, the encoder neural network has to be able to receive images having a given resolution as input with a depth of 3 (if it receives RGB images). It also has to be able to output an encoded image which can be rotated, and this corresponds to given numbers of neurons for the first layer of the encoder neural network and the final layer of the encoder neural network. The dimensions of this encoded image can be found in a calibration step. Consequently, the first layer of the decoder neural network has the same number of neurons as the last layer of the encoder neural network, as it is able to receive encoded images, and the final layer of the decoder neural network has the same number of neurons as the first layer of the encoder neural network, as it is able to output images.

It should be noted that the encoder neural network and the decoder neural network form an auto-encoder, using an expression well known to the person skilled in the art.

The person skilled in the art will also know how to determine the distance between two images, for example the distance between the output of the decoder neural network and the second image, or the distance between the output of the neural network and the corresponding viewpoint in the first set.

In the above method, it is not necessary to know the rotation between two images of a pair of images, the rotation to be applied is only obtained from the viewpoint of the second image. In fact, it has been observed by the inventors that the encoder neural network may produce encoded images that are associated with a generic/canonical viewpoint, applying the rotation obtained from the second image is sufficient to obtain a rotated encoded image which will lead to a decoded image which is close to the second image, also in terms of viewpoint. This behavior is a result of the training.

Also, the above method may be able to determine automatically the viewpoints of objects from the given category, or objects from a plurality of categories. In some embodiments, the images used in the above method only show one object of this plurality of category per image.

According to a particular embodiment, the viewpoint of an object visible on an image comprises 3 values defining a (3D) vector expressed in a referential centered with respect to the object and oriented towards the image acquisition apparatus used to acquire the image.

This referential may be aligned according to the category of object. For example, for a car, the referential can be centered around the center of the car, and a first axis may go from the front to the back of the car, a second from a side to another side, and the third is vertical and perpendicular to the other two. Different categories may have different referentials.

Also, this vector corresponds to the three elements which define a viewpoint (i.e. the azimuth, the elevation, and the in-plane rotation).

From these three values, it is possible to deduce in a simple manner a rotation matrix which can then be applied to the encoded image.

Alternative representations of the viewpoint may also be used, for example such as quaternions.

According to a particular embodiment, the encoded image is a vector having a resolution which is lower than the resolution of the image.

Obtaining a vector as output of the encoder neural network can be done by having a fully connected layer as the last layer of the encoder neural network.

For example, the resolution of the vector is its depth, and the resolution of the image is its width multiplied by its height multiplied by 3 (RGB image). It has been observed that a lower resolution for the vector provides a better encoding of global information from the images.

According to a particular embodiment, the resolution of the encoded image is a multiple of three.

For example, the depth of the vector can be expressed as 3 times k, with k being an integer.

This particular embodiment facilitates the multiplication of the encoded image by a rotation matrix obtained from the viewpoint outputted by the neural network.

According to a particular embodiment, training the neural network is performed using the following loss function:

$$L = {min}_{{θ}_{v} , {θ}_{e} , {θ}_{d}} \begin{matrix}{\sum }_{( I , v ) ∈ T} {‖ {f}_{v} ( I ; {θ}_{v} ) - v ‖}^{2} \\ {+ λ {\sum }_{( I , {I}^{′} ) ∈ T} ‖ {f}_{d} ( R ( {f}_{v} ( {I}^{′} ; {θ}_{v} ) ) \times {f}_{e ( I ; {θ}_{e} )} ) ; {θ}_{d} ) - {I}^{′} ‖}^{2}\end{matrix}$$

wherein:

L is the loss,

T is the first set of training images,

U is the second set of pairs of training images,

I is a first image of a pair of training images of the second set of training images or an image of the first training set,

I′ is a second image of a pair of training images,

ƒᵥ, ƒₑ, and ƒ_{d} are respectively the neural network, the encoder neural network, and the decoder neural network,

θᵥ, θₑ, and θ_{d} are respectively the parameters of ƒᵥ, ƒₑ, and ƒ_{d},

v is the viewpoint of image I,

R(x) is a function which determines a rotation associated with viewpoint x, and

λ is a hyperparameter of the training.

It should be noted that if T comprises pairs of images of a same object under different viewpoints, images from T may also be used in the second sum to perform the training.

Also, this training may be performed by processing batch of images from T and U chosen randomly. For each batch of images, the two sums are calculated before performing a method such as the stochastic gradient method on the basis of the above formula.

By way of example, each batch comprises 64 individual images.

According to a particular embodiment, distances (i.e. ∥x∥) are calculated using the perceptual loss.

Using the perceptual loss has been observed by the inventors to provide a high-quality reconstruction (i.e. the operation of the decoder neural network). By high-quality, what is meant is that the images obtained from the decoder neural network are not blurry, which may happen when using other distances (for example the L1 or the L2 norm).

According to a particular embodiment, the neural network, and/or the encoder neural network, and/or the decoder neural network are convolutional neural networks.

The disclosure also provides a neural network trained by the method as defined above.

This neural network may be stored on a recording medium.

The disclosure also provides a system for training a neural network to deliver the viewpoint of a given object visible on an image when this image is inputted to this neural network, the system comprising:

an encoder neural network configured to receive an image as input and to deliver an encoded image,

a decoder neural network configured to receive an encoded image having the same dimensions as an encoded image delivered by the encoder neural network, and configured to output a decoded image,

a first set of training images with, for each image, the viewpoint of an object belonging to a given category which is visible on the image,

a second set of training image pairs, wherein each pair of the second set of training image pairs comprises:
a first image on which an object belonging to the given category is visible;
a second image on which the object of the first image is visible with a viewpoint which differs from the viewpoint in the first image,

and a training module configured to adapt the parameters of the neural network, the parameters of the encoder neural network, and the parameters of the decoder neural network by minimizing the distances between:
for each training image of the first set of training images, the output of the neural network when the training image is inputted to the neural network, with the viewpoint of this training image,
for each pair of the second set of training image pairs, the second image of each pair of the second set of training image pairs with the output of the decoder neural network when:
   the first image of this pair is inputted to the encoder neural network to obtain an encoded image,
   the second image of this pair is inputted to the neural network to obtain a viewpoint,
   the encoded image is rotated by a rotation corresponding to this viewpoint to obtain a rotated encoded image,
   the rotated encoded image is inputted into the decoder neural network to obtain the output of the decoder neural network.

This system may be configured to perform any one of the embodiments of the above defined method.

The disclosure also provides a system including the neural network.

The disclosure also provides a vehicle comprising the system as defined above.

In one particular embodiment, the steps of the method are determined by computer program instructions.

Consequently, the disclosure is also directed to a computer program for executing the steps of a method as described above when this program is executed by a computer.

This program can use any programming language and take the form of source code, object code or a code intermediate between source code and object code, such as a partially compiled form, or any other desirable form.

The disclosure is also directed to a computer-readable information medium containing instructions of a computer program as described above.

The information medium can be any entity or device capable of storing the program. For example, the medium can include storage means such as a ROM, for example a CD ROM or a microelectronic circuit ROM, or magnetic storage means, for example a diskette (floppy disk) or a hard disk.

Alternatively, the information medium can be an integrated circuit in which the program is incorporated, the circuit being adapted to execute the method in question or to be used in its execution.

### BRIEF DESCRIPTION OF THE DRAWINGS

How the present disclosure may be put into effect will now be described by way of example with reference to the appended drawings, in which:

FIG. 1 is a schematic representation of the viewpoint of an object observed by a camera,

FIG. 2 is a schematic representation of the structure of the neural networks used during the training,

FIG. 3 is a schematic representation of a system according to an example, and

FIG. 4 is a vehicle according to an example.

### DESCRIPTION OF THE EMBODIMENTS

An exemplary method for training a neural network to deliver the viewpoint of a given object visible on an image will now be described.

The viewpoint of an object is defined as the combination of the azimuth angle of the object with respect to a camera, the elevation of the object, and the in-plane rotation of the object.

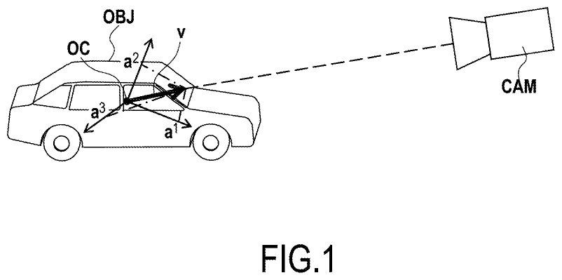

On FIG. 1, an object OBJ (here a car) has been represented in a scene which is observed by camera CAM (i.e. the object will be visible in images acquired by the camera CAM). The viewpoint of an object OBJ seen by a camera CAM can be expressed in different manners, for example using the axis-angle representation, a unit quaternion, or a rotation matrix. In the present description, the viewpoint (azimuth, the elevation, and the in-plane rotation) is expressed using a vector v of three values, which are the coordinates of this vector which starts at the origin of a referential placed with respect to the object OBJ and which is oriented towards the camera CAM. On the FIG. 1, this referential is placed at the center OC of the object, and the three coordinates are a¹, a², and a³.

In some embodiments, the vector v has a norm of 1 (the three coordinates define a point on a sphere of radius 1, as this facilitates expressing a rotation, as will be described hereinafter.

Also, the referential is associated with a given orientation of the object OBJ, for all the objects having the same category (for example car).

The methods of the disclosure relate to training a neural network so that it can output the three values a¹, a², and a³.

As can be conceived by the person skilled in the art, this training will be directed to categories of objects. For example, the neural network will be trained to deliver the viewpoint of a car when a car is visible on the image. The disclosure is however not limited to the detection of the viewpoint of a car but can also concern other objects, including objects which can be observed on a road.

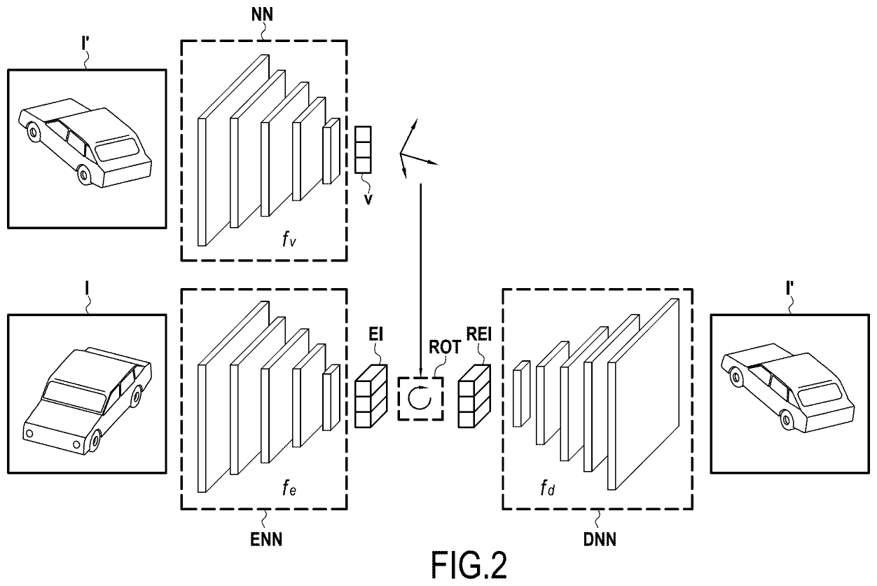

FIG. 2 is a schematic representation of the structure of the neural networks used during the training, and of the neural network which will be trained.

On the FIG. 2, reference NN designates the neural network to be trained (also called “the neural network” in the present description for the sake of simplicity). The neural network NN is, in the illustrated example, a convolutional neural network having multiple layers, which can use 3×3 convolutions. By way of example, batch normalization layers and activation functions may also be used according to standard practices in the art. In fact, the person skilled in the art will know how to design a neural network suitable for the task of delivering viewpoints (a vector of three values) when an image is inputted to this neural network (a matrix of vectors having a depth equal to 3 (RGB)).

On the FIG. 2, the inputted image is designated as I′ for reasons which will become clearer hereinafter. The viewpoint is designated as v.

For a given set of m labelled images with their ground-truth viewpoints with respect to a camera defined as T={(Iᵢ,vᵢ)}ᵢ₌₁^{m}, where Iᵢ is an RGB image which belongs to I and vᵢ=(a¹, a², a³)∈V is the three dimensional vector of the ground-truth viewpoint of objects visible on each image. The neural network NN performs the function ƒᵥ:I→V such that ƒᵥ(I;θᵥ)=v where θᵥ are the parameters of ƒᵥ. In a manner which is known in the art, it is possible to train this neural network by minimizing the following sum:

$${\sum }_{( I , v ) ∈ T} {‖ {f}_{v} ( I ; {θ}_{v} ) - v ‖}^{2}$$

This training will include adapting θᵥ, for example by performing a stochastic gradient descent.

It should be noted that this training is often designated as supervised training.

In the present method, additional images are used to train the neural network. T is a first set of training images, and a second set of training images u is also provided. The images of the second set can be unlabeled, which means that there is no a priori knowledge of the viewpoint of the objects visible on the images of this set.

The second set contains training image pairs, with each pair containing:
a first image on which an object belonging to the given category is visible; and
a second image on which the object of the first image is visible with a viewpoint which differs from the viewpoint in the first image.

Thus, the second set U is designated as U={(Iᵢ;Iᵢ′)} and each pair contains images of a same object, for example a same car or plane, captured at different viewpoints.

In order to use the second set U to train the neural network NN, an encoder neural network ENN is provided. This encoder neural network is configured to receive an image (I on the figure) as input, and to deliver an encoded image as output (EI on the figure).

For example, the encoder neural network is a convolutional neural network including five blocks, with each block comprising two convolutional layers with the second convolutional layer using stride in order to reduce spatial dimensions. The convolutions are 3×3 convolutions with a channel depth which starts at 32 and which doubles every block. These five blocks of the encoder neural network are further connected to a fully connected layer.

Because a fully connected layer is used, the output of the encoder neural network is a vector. In some embodiments, the depth of this vector is lower than the resolution image I (image height times image width times 3 for RGB). Also, the resolution of this vector may be a multiple of three so as to facilitate a subsequent rotation.

On the FIG. 2, the encoder neural network ENN receives an image I from a pair of images and outputs the encoded image EL The operation of the encoder neural network ENN is written as ƒₑ(I;θₑ), with θₑ being the parameters of the encoder neural network ENN which will be adapted during training.

Also, there is provided a decoder neural network DNN configured to receive an encoded image as input having the same dimensions as the encoded images outputted by the encoder neural network ENN, and configured to output images which have the same dimensions as the images inputted to the encoder neural network ENN.

On the FIG. 2, the decoder neural network DNN receives a rotated encoded image REI, this rotation will be described hereinafter, and outputs an image which is designated as I′.

The structure of the decoder neural network is a mirrored version of the structure of the decoder neural network.

It appears that the encoder neural network and the decoder neural network form an auto-encoder.

The operation of the decoder neural network, for example when used in an auto-encoder operation, can be written as ƒ_{d}(ƒe(I;θₑ);θ_{d}), with θ_{d} being the parameters of the decoder neural network ENN which will be adapted during training.

While it is possible to obtain decoded images from encoded images which correspond to the original image, information regarding the viewpoint may not be clearly usable in the encoded image. Instead, the present method involves a conditional image generation technique.

In the present method, for a given pair of images (Iᵢ;Iᵢ′) that show a same object under different viewpoints, the viewpoint of the object visible on a second image I′ of a pair will be used to deduce a rotation ROT to be applied to an encoded image obtained from the first image I of this pair, before inputting the rotated image to the decoder neural network. Consequently, the image delivered by the decoder neural network should correspond to the second image I′, or, at least, minimizing the distance between I′ and the output of the decoder neural network is the goal of the training. Thus, on the FIG. 2, the reference I′ is also used to designate the output of the decoder neural network.

If the viewpoint of image I′ is unknown (i.e. I′ is an unlabeled image), determining this viewpoint may be done using the neural network NN. The neural network NN outputs a viewpoint v from which a rotation matrix can be deduced to perform a rotation operation ROT which will rotate the encoded image EI into a rotated encoded image REI. A multiplication between the rotation matrix and the vector/encoded image EI which has a resolution which is a multiple of three.

By way of example, deducing this rotation matrix from the viewpoint of v can be performed using the “look at” transformation which is well known to the person skilled in the art. For example, this transformation is used in the library OpenGL in its version 2.1. An explanation of the operation of this transformation is present in August 2020 at URL: https://www.khronos.org/registry/OpenGL-Refpages/gl2.1/xhtml/gluLookAt.xml. In the example described at this URL, “eye” is equivalent to the viewpoint, “center” is set at (0,0,0) and “up” at (0,0,1).

This feature addresses the lack of ground-truth for I′, and extends the learning of the encoder/decoder neural network to unlabeled images by allowing gradients originating from the decoder to be back-propagated to the neural network NN. On the FIG. 2, I′ is therefore used to designate both the input of the neural network NN, and the output of the decoder neural network DNN.

The above use of the neural network NN leads to a training which can be designated as unsupervised training.

It can be conceived that using the neural network NN to obtain the viewpoint is only relevant if the neural network NN is trained and accurate. In order to synergistically use the labeled images and the unlabeled images during the training so as to better train the neural network NN, it is proposed to combine in a single loss function a loss associated with the unlabeled images U and a loss associated with the labeled images T. Thus, the present method combines a supervised training and an unsupervised training.

In the present method, training the neural network NN comprises adapting the parameters of the neural network NN, the parameters of the encoder neural network ENN, and the parameters of the decoder neural network DNN (respectively θᵥ, θₑ, θ_{d}) by minimizing the distances between:
for each training image of the first set T of training images, the output of the neural network when the training image is inputted to the neural network, with the viewpoint of this training image,
for each pair of the second set U of training image pairs, the second image of each pair of the second set of training image pairs with the output of the decoder neural network when:
   the first image/of this pair is inputted to the encoder neural network ENN to obtain an encoded image EI,
   the second image I′ of this pair is inputted to the neural network NN to obtain a viewpoint v,
   the encoded image EI is rotated by a rotation ROT corresponding to this viewpoint to obtain a rotated encoded image REI,
   the rotated encoded image REI is inputted into the decoder neural network DNN to obtain the output of the decoder neural network DNN.

In other words, the following loss function L is used:

$$L = {min}_{{θ}_{v} , {θ}_{e} , {θ}_{d}} \begin{matrix}{\sum }_{( I , v ) ∈ T} {‖ {f}_{v} ( I ; {θ}_{v} ) - v ‖}^{2} \\ {+ λ {\sum }_{( I , {I}^{′} ) ∈ T} ‖ {f}_{d} ( R ( {f}_{v} ( {I}^{′} ; {θ}_{v} ) ) \times {f}_{e ( I ; {θ}_{e} )} ) ; {θ}_{d} ) - {I}^{′} ‖}^{2}\end{matrix}$$

In the above equation, λ is a hyperparameter having a value which will be set during a calibration step. This hyperparameter indicates a tradeoff between the unsupervised and supervised training.

While the above formula is directed to using the entirety of T and U, training may be performed iteratively, with each iteration comprising selecting a given number of individual images (for example 64) from T and U so as to use them in the above two sums for calculating a loss to be used in the back-propagation (for example using the stochastic gradient method or another method).

Thus, a batch-training is performed.

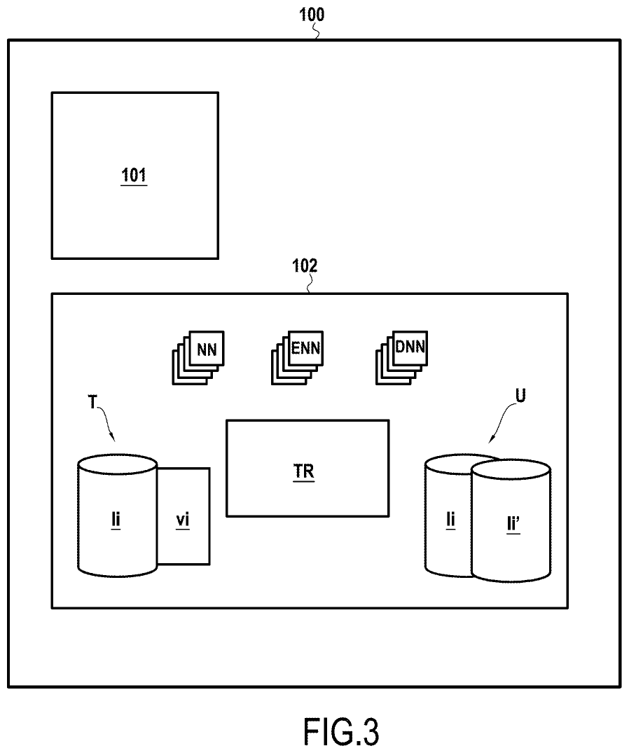

FIG. 3 is a schematic representation of a system 100 configured to perform the method described in relation to FIG. 2.

This system 100 comprises a processor 101 and a non-volatile memory 102. The system 100 therefore has a computer system structure.

In the non-volatile memory 102, the neural network NN, the encoder neural network ENN, and the decoder neural network DNN are stored.

Additionally, the first set T and the second set U are stored in the non-volatile memory 102.

A training module TR is also stored in the non-volatile memory 102 and this module can consist of computer program instructions which, when executed by the processor 101, will perform the training and adapt the weights θᵥ, θₑ, and θ_{d}.

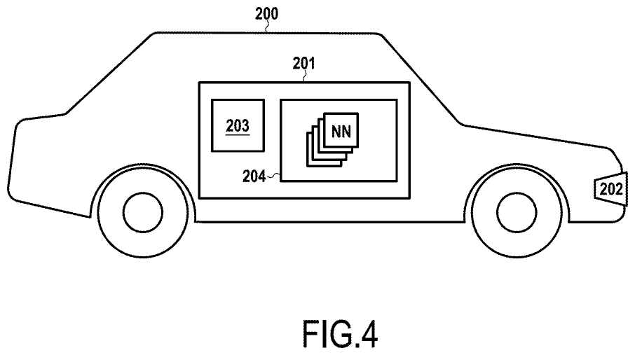

FIG. 4 is a schematic representation of a vehicle 200, here a car, equipped with a system 201 for determining the viewpoints of objects visible on images acquired by a camera 202 of the vehicle 200.

The system 201 comprises a processor 203 and a non-volatile memory 204 in which the neural network NN is stored after the training described in reference to FIG. 2 has been performed.

The above-described training allows obtaining neural networks which have been observed to perform better at detecting viewpoints than neural networks simply trained using a labelled set of training images (supervised training). Notably, it has been observed that various increases of accuracy can be obtained using a portion of the labelled dataset using for training.

What is claimed is:

1. A method for training a neural network to deliver a viewpoint of a given object visible on an image when this image is inputted to this neural network, the method comprising:
providing an encoder neural network configured to receive an image as input and to deliver an encoded image,
providing a decoder neural network configured to receive an encoded image having the same dimensions as an encoded image delivered by the encoder neural network, and configured to output a decoded image,
providing a first set of training images with, for each image, the viewpoint of an object belonging to a given category which is visible on the image, and
providing a second set of training image pairs, wherein each pair of the second set of training image pairs comprises:
a first image on which an object belonging to the given category is visible; and
a second image on which the object of the first image is visible with a viewpoint which differs from the viewpoint in the first image, and
wherein training the neural network comprises adapting parameters of the neural network, parameters of the encoder neural network, and parameters of the decoder neural network by minimizing the distances between:
for each training image of the first set of training images, the output of the neural network when the training image is inputted to the neural network, with the viewpoint of the training image, and
for each pair of the second set of training image pairs, the second image of each pair of the second set of training image pairs with the output of the decoder neural network when:
the first image of this pair is inputted to the encoder neural network to obtain an encoded image,
the second image of this pair is inputted to the neural network to obtain a viewpoint,
the encoded image is rotated by a rotation corresponding to this viewpoint to obtain a rotated encoded image, and
the rotated encoded image is inputted into the decoder neural network to obtain the output of the decoder neural network.

2. The method of claim 1, wherein the viewpoint of an object visible on an image comprises 3 values defining a vector expressed in a referential centered with respect to the object and oriented towards an image acquisition apparatus used to acquire the image.

3. The method of claim 1, wherein the encoded image is a vector having a resolution which is lower than the resolution of the image.

4. The method of claim 1, wherein the dimension of the encoded image is a multiple of three.

5. The method of claim 1, wherein training the neural network is performed using the following loss function:
$$L = {min}_{{θ}_{v} , {θ}_{e} , {θ}_{d}} \begin{matrix}{\sum }_{( I , v ) ∈ T} {‖ {f}_{v} ( I ; {θ}_{v} ) - v ‖}^{2} \\ {+ λ {\sum }_{( I , {I}^{′} ) ∈ T} ‖ {f}_{d} ( R ( {f}_{v} ( {I}^{′} ; {θ}_{v} ) ) \times {f}_{e ( I ; {θ}_{e} )} ) ; {θ}_{d} ) - {I}^{′} ‖}^{2}\end{matrix}$$
wherein:
L is the loss,
T is the first set of training images,
U is the second set of training image pairs,
I is a first image of a pair of training images of the second set of training image pairs or an image of the first set of training images,
I′ is a second image of a pair of training images,
ƒᵥ, ƒₑ, and ƒ_{d} are respectively the neural network, the encoder neural network, and the decoder neural network,
θᵥ, θₑ, and θ_{d} are respectively the parameters of ƒᵥ, ƒₑ, and ƒ_{d},
v is the viewpoint of image I,
R(x) is a function which determines a rotation associated with viewpoint x, and
λ is a hyperparameter of the training.

6. The method of claim 5, wherein distances are calculated using perceptual loss.

7. The method of claim 1, wherein the neural network, and/or the encoder neural network, and/or the decoder neural network are convolutional neural networks.

8. A neural network trained by the method according to claim 1.

9. A system for training a neural network to deliver a viewpoint of a given object visible on an image when this image is inputted to this neural network, the system comprising:
an encoder neural network configured to receive an image as input and to deliver an encoded image,
a decoder neural network configured to receive an encoded image having the same dimensions as an encoded image delivered by the encoder neural network, and configured to output a decoded image,
a first set of training images with, for each image, the viewpoint of an object belonging to a given category which is visible on the image, and
a second set of training image pairs, wherein each pair of the second set of training image pairs comprises:
a first image on which an object belonging to the given category is visible; and
a second image on which the object of the first image is visible with a viewpoint which differs from the viewpoint in the first image, and
a training module configured to adapt parameters of the neural network, parameters of the encoder neural network, and parameters of the decoder neural network by minimizing distances between:
for each training image of the first set of training images, the output of the neural network when the training image is inputted to the neural network, with the viewpoint of the training image, and
for each pair of the second set of training image pairs, the second image of each pair of the second set of training image pairs with the output of the decoder neural network when:
the first image of this pair is inputted to the encoder neural network to obtain an encoded image,
the second image of this pair is inputted to the neural network to obtain a viewpoint,
the encoded image is rotated by a rotation corresponding to this viewpoint to obtain a rotated encoded image, and
the rotated encoded image is inputted into the decoder neural network to obtain the output of the decoder neural network.

10. A system including the neural network according to claim 8.

11. A vehicle comprising the system according to claim 10.

12. A recording medium readable by a computer and having recorded thereon a computer program including instructions for executing the method according to claim 1.
